(19) United States
(12) Patent Application Publication
(10) Pub. No.: US 2026/0001101 A1
(43) Pub. Date: Jan. 1, 2026

(54) MACHINE FOR FRACTIONATING GROUND CEREAL PRODUCTS

(71) Applicant: SWISCA AG, Appenzell (CH)

(72) Inventors: Jonas Schär, Appenzell (CH); Oliver Ensslin, Appenzell (CH); Adrian Schaffer, Appenzell (CH)

(21) Appl. No.: 18/874,212

(22) PCT Filed: Jun. 9, 2023
(86) PCT No.: PCT/EP2023/065557

§ 371 Date: Dec. 12, 2024

(30) Foreign Application Priority Data
Jun. 15, 2022 (CH) CH000722/2022

(51) Int. Cl. B07B 1/38; B07B 1/42

(52) U.S. Cl. CPC B07B 1/38; B07B 1/42

(57) ABSTRACT

A machine for fractionating ground cereal products includes a plurality of sieve stack pairs which are arranged next to one another, each with an upper sieve stack and a lower sieve stack. A drive module that includes an electric motor and an inertial weight which can be driven by this into a rotation movement is assigned to the sieve stack pairs. The drive module is arranged between the upper and the lower sieve stack of the respective sieve stack pair. The upper sieve stack pair and the lower sieve stack can be roughly equally large, i.e. the number of sieves of the upper sieve stack and of the lower sieve stack can be roughly equal or differ for example by maximally 50% or maximally 30%.

### BACKGROUND OF THE INVENTION

### Field of the Invention

The invention relates to a machine for fractionating ground cereal products, for example a plansifter or a purifying machine.

### Description of Related Art

Machines for fractionating ground cereal products serve for the separation of constituents of a ground product into coarse or finer grained constituents and under certain circumstances also into constituents of different densities and/or for the removal of foreign bodies from the ground product. The separating of the ground product into differently grained constituents is also denoted as “grading” or “fractionating”. Plansifters are generally used in the milling industry for fractionating ground cereal products between and after passages through the roller mill of a cereal mill. They can also be applied for so-called control sifting, i.e. sieving of flour which per se is ready for sale.

Plansifters include stacks of sieves which function as plane sieves, the stacks being enclosed in so-called “sieve compartments” or “sieve boxes” with side walls and a lid. These are brought into horizontally oscillatory movements, in particular into circular oscillations in the sieve plane, by way of a drive mechanism.

According to the state of the art, the drive functions as follows: an even number of sieve boxes are coupled to one another and arranged in two rows. A drive module which includes an inertial weight which is brought into a circling motion via a belt drive is situated between the rows. The sieve box group with the drive module is herein mounted in a suspended manner, so that the inertial weight on the one hand and the centre of gravity of the sieve box on the other hand together form a flywheel mass system and offset to one another by 180° circle about a common rotation axis (orbital axis).

This tried and trusted system firstly has the disadvantage that a distance for the drive module must be present between the rows of sieve boxes, such entailing a considerable space requirement. Secondly, there is the disadvantage of the limited adaptability: in order for the number of sieve boxes to be able to be increased or reduced, a drive which is dimensioned for the maximal number of sieve boxes must always be used, i.e. the drive is over-dimensioned for many application situations. Thirdly, the forces upon the mounting of such an inertial weight are considerable and the demands accordingly high.

Stand-alone plansifters which consist of a single sieve compartment with a single drive are likewise known. FR 1 426 099 and FR 840 946 each show an embodiment of such a standalone plansifter with a drive module which is arranged in the middle, thus between an upper and a lower part-sieve-stack GB 201013 discloses plansifters with one or with two sieve compartments, with a drive module in the middle, wherein with regard to embodiments with two sieve compartments, a common drive module is present for both sieve compartments.

In EP 2 114 582 it has been suggested to provide each sieve compartment with an individual drive, so that the plansifter can not only have an even, but also an odd number of sieve compartments. The drive each includes a drive device on the lid and on the base, wherein the drive devices consist of annular crown gears which interact with coils which are arranged on the outer ring and together with these form a reluctance motor. Inlet openings and outlet openings are arranged in the inside of the crown gears. This solution permits a flexible arrangement of the sieve compartments. However, the power capability of the drive units is limited, and the necessity of a drive unit each on the lid and the base renders the design comparatively cumbersome.

### SUMMARY OF THE INVENTION

It is the object of the invention to provide a machine for fractionating ground cereal products, in particular a plansifter or a purifying machine which overcomes the disadvantages of the state of the art and which is flexible, robust and simple in design.

According to an aspect of the invention, the machine for fractionating ground cereal products includes a plurality of sieve stack pairs which are arranged next to one another, each with an upper sieve stack and a lower sieve stack. A drive module is assigned to each of the sieve stack pairs, the drive module including an electric motor and an inertial weight which can be driven by this into a rotatory movement, i.e. a mass which is arranged eccentrically with respect to the rotation axis of the rotation movement. Herein, the drive module is arranged between the upper and the lower sieve stack of the respective sieve stack pair. The upper sieve stack and the lower sieve stack can be roughly equally large, i.e. the number of sieves of the upper sieve stack and of the lower sieve stack can be equal or differ for example by maximally 50% or maximally 30%.

The machine is for example a plansifter or a purifying machine for separating the ground product from contamination.

The sieve stack pairs which are arranged next to one another are mechanically coupled to one another in the context of them being able to execute common, in particular horizontally circling oscillations.

In the present text, “sieve stack” denotes an arrangement of sieves which are arranged above one another. Herein, the sieves do not necessarily need to lie on one another, but can also be held by an external carrier structure, such as a box, with slide-in groves for the sieves.

Due to the rotation movements of the inertial weights, the machine is configured to bring the sieve elements of the sieve stack into oscillations, for example in the form of circling movements. In the context of the present text, when one speaks of “oscillations” these are also to be understood as circling movements.

The arrangement with the drive module between the upper and the lower sieve stack has the advantage that one distributes into the inertial weight in a discretised manner to where the mass forces also occur per sieve stack pair. The force flows are discretised and minimised by way of this. The necessary bearings are accordingly loaded to a lesser extent and can be dimensioned smaller and/or the service life can be increased. The total weight also becomes smaller which in turn has a positive effect on the mountings. Furthermore, no additional space for a central drive unit is necessary between the sieve stacks. Furthermore, the procedure according to the invention also permits the machine to able to be constructed from a practically arbitrary number of sieve stack pairs, wherein the drive is always dimensioned in a suitable manner according to design and the energy consumption and material wear are also adapted to the number of sieve stack pairs.

The sieve stacks, as known per se, can be arranged in sieve boxes. Alternatively, one can also make do without the use of such closed boxes by way of the sieve elements being shaped such that they can be stacked upon one another and without making do of the use of an external housing structure.

The sieves of the sieve stacks in particular are plane sieves, i.e. they are aligned horizontally. The sieve plane is therefore in particular parallel to the oscillation plane.

In particular, the machine is configured to synchronously oscillate the inertial weights of the drive modules.

The drive modules can each include a shaft which is rotatable relative to a main body, for example to a housing and to which the inertial weight is fastened. The mounting of the shaft relative to the main body can be effected in a manner known per se by way of a bearing, for example a ball bearing, at both end sides of the shaft. The dimensioning of the bearings is adapted to the constant loading which acts during the operation on account of the rotating inertial weight thereupon, and which is significantly less than with corresponding bearings of central drive modules according to the state of the art.

In embodiments, the shaft is driven directly by the electric motor by way of the rotor of the electric motor being connected to it in a rotationally fixed manner or even being formed by a for example magnetic portion of the shaft. Such a solution which is free of gears or other elements which convert the rotation speed (such as for example belts or the like) is particularly compact and moreover particular low in maintenance.

The motors can be synchronous motors, in particular with permanent magnets. Inner rotor motors as well as outer rotor motors are conceivable, wherein an arrangement with an inner rotor which includes permanent magnets can be particularly efficient.

The drive modules can each include a plurality of through-channels for the product to be sieved. Hence it is possible for the shares of the product which are envisaged for this to get from the upper sieve stack to the lower sieve stack and from there to get to the location which is provided for this. A separate device for leading through these shares does not need to be present on the sieve compartments and/or drive modules at the outside due to the through-channels. This is conducive to the compact construction manner.

Due to the provision of the through-channels, the sieve stack pairs form functional units which functionally correspond to a sieve stack/sieve compartment of a plansifter (or a purifying machine) according to the state of the art which includes roughly the same number of sieves as the upper and the lower sieve stack together.

The through-channels in particular can lie radially outside the path of the inertial weight. By way of this, a construction concerning which the inertial weight is fixedly fastened to the shaft of the drive module is rendered possible. The through-channels can be designed as elongate slots. Given a rectangular layout of the drive modules, they can run parallel to the radially outer sides. The number of through-channels can be for example 8.

A rectangular, for example square layout of the drive modules can be particularly advantageous, since on account of this the drive modules can be arranged next to one another in a simply constructed mount.

Such a common mount can be advantageous independently of the shape of the drive modules. It can form the mechanical carrier structure of the machine and also include structures for a suspension device, by way of which the machine (what is meant here are parts of the machine which are to be brought into circling oscillations, thus of course without control components or power electronics components) can be suspended. The mount can furthermore receive the upper sieve stack by way of this lying on the mount in a direct or indirect (for example via the drive modules on which they lie) manner, whilst the lower sieve stacks are suspended thereon.

Such a common mount therefore commonly receives the drive modules. Due to this, the drive modules include a common mechanical carrier structure and are mechanically coupled to one another. The machine is therefore not merely a grouping of a plurality of standalone sifters which are arranged next to one another, but a larger mechanical unit. It has been found that the advantages of standalone plansifters (flexibility) can be combined with the advantages of larger machines (in particular greater efficiency) by way of the concept of having a centrally arranged drive module per sieve stack pair with the common mechanical carrier structure, and specifically with an always optimised drive power and with a minimal spatial requirement.

Such a common mount in particular is arranged centrally with respect to the vertical, thus between the upper and the lower sieve stack. The drive modules—i.e. their electric motors and inertial masses with housing—are received by the common mount. In particular, they can be received by the mount in a direct manner, i.e. they do not lie on a sieve of the sieve stack.

Supplementarily or alternatively, the mount can also receive electrical leads for supplying the electric motors, for example in the inside of frame parts which form the mount.

In embodiments, a plurality of the electric motors of the drive modules are suspended on a common power stage, i.e. they are fed by the common power stage. By way of this, power electronics components as well as cables etc. can be done away with. Even if a drive module and hence an electric motor is present per sieve stack pair and therefore more electric motors are required than according to the state of the art, the electric motors can be operated and supplied per cluster with a common power stage just as a single electric motor, which is very economical.

If several electric motor clusters and accordingly several power stages are present in the machine, then the control for the power switches in the power stages can be effected by way of a common control module.

Alternatively, each drive module can have an individual power stage.

In embodiments, the machine is configured such that the speed of the electric motors is selectable and able to be read off. The sieve efficiency can thus be optimised particularly well by way of the selection of the suitable speed, for example depending on the material to be sieved.

In particular, given embodiments with at least one electric motor cluster with a common power stage, the drive modules can furthermore be provided with a mechanical stop which limits a movement counter to the envisaged rotation direction (backwards rotation) of the inertial weights, whilst a movement in the forwards direction (the envisaged rotation direction) is not prevented.

The machine can be configured to carry out the following method on starting: firstly the inertial weights are slowly moved in the backwards direction until they are definitively present on the mechanical stop. The motors are therefore firstly moved backwards very slowly and with very little current, up to a mechanical stop. If a motor is on a mechanical stop, the electrical rotary field continues to rotate and the stall torque is exceeded. The rotary field is rotated further, so that the other motors can also rotate further in the direction of the stop. This rearward movement happens until all motors are at their mechanical stop. This can be ensured by way of the rotary field being subjected to a rotation of roughly 360° or more.

This method as the case may be can be carried out in particular for each power stage.

In particular, the mechanical stop can be formed by a swing element which can be deflected relative to the inertial weight between a home position and a deflected position. If the swing element is in the home position, then given a movement in the rearward direction it is present on a stop element when the inertial weight has reached an angular position which is defined by the stop element. Given a movement in the forwards direction, the swing element is deflected by a ramp, so that the stop element does not prevent the movement in the forwards direction. Furthermore, the swing element can be designed such that on account of its centre of gravity position it is deflected by the centrifugal force into the deflected position when the inertial weight rotates rapidly enough, so that it does not come into contact with the ramp with each revolution.

As an alternative to the previously outlined procedure, alternative ways of aligning the inertial weights are also considered. For example, instead of the use of a mechanical stop, the motors within a cluster can be individually controlled with switches (“contactors”). For this, the motors, for example in a successive manner, would have been brought into a defined position way of an encoder or resolver. Under certain circumstances, a means, e.g. a friction brake could be provided, in order to hold the position of the motors before they are then all brought into the synchronous rotation movement with one another by way of them being supplied with current accordingly.

Optionally, a sensor can be present for example per drive module, the sensor detecting the position of the inertial weight, for example by way of it determining in each case when the inertial weight is in the direct vicinity of a sensor position.

In embodiments, concerning which each drive module has its own power stage, such a sensor signal can be sufficient for the alignment. A synchronisation of the rotation movement can then also be effected during running operation-or in particular during starting operation.

Apart from the machine, a method for operating the machine is also the subject-matter of the present invention. Apart from the provision of the machine as defined above, with or without particular features of embodiments of the invention, the method includes the step of the synchronous driving of the inertial weights of the drive modules in order to bring the sieve compartments into oscillations. For this purpose, the machine-or more precisely a mechanically coupled unit of sieve stacks and drive motors and possibly the mount (without control components and power electronics components of the machine) can be mounted or suspended such that it is it is capable of horizontally circling oscillations.

Optionally, the method also includes the step of starting the machine by way of the inertial weights on starting firstly being moved slowly rearwards until they reach a mechanical stop and only subsequently being driven into a rotation movement in the forwards direction by way of their electric motors.

### BRIEF DESCRIPTION OF THE DRAWINGS

Embodiment examples of the invention are hereinafter described by way of drawings. In the drawings, the same reference numerals denote equal or analogous elements. The drawings show elements which partly correspond to one another in sizes which differ from figure to figure. There are shown in:

FIG. 1: a view of a plansifter;

FIG. 2: the view of the plansifter according to FIG. 1 with partly removed sieve stacks and with two removed drive modules;

FIG. 3: a lower view of the mount;

FIG. 4 a view of a drive module for a plansifter according to FIG. 1;

FIG. 5 a plan view upon the drive module of FIG. 4;

FIG. 6 a representation of the drive module of FIG. 4 and FIG. 5 which is sectioned along the plane VI-VI;

FIGS. 7 and 8 a detail of the drive module with two different positions of the swing tab;

FIG. 9 a schematic diagram of the electric motors of the eight drive modules of the plansifter according to FIG. 1; and

FIG. 10 a plurality of possible arrangements of sieve stack pairs.

### DETAILED DESCRIPTION OF THE INVENTION

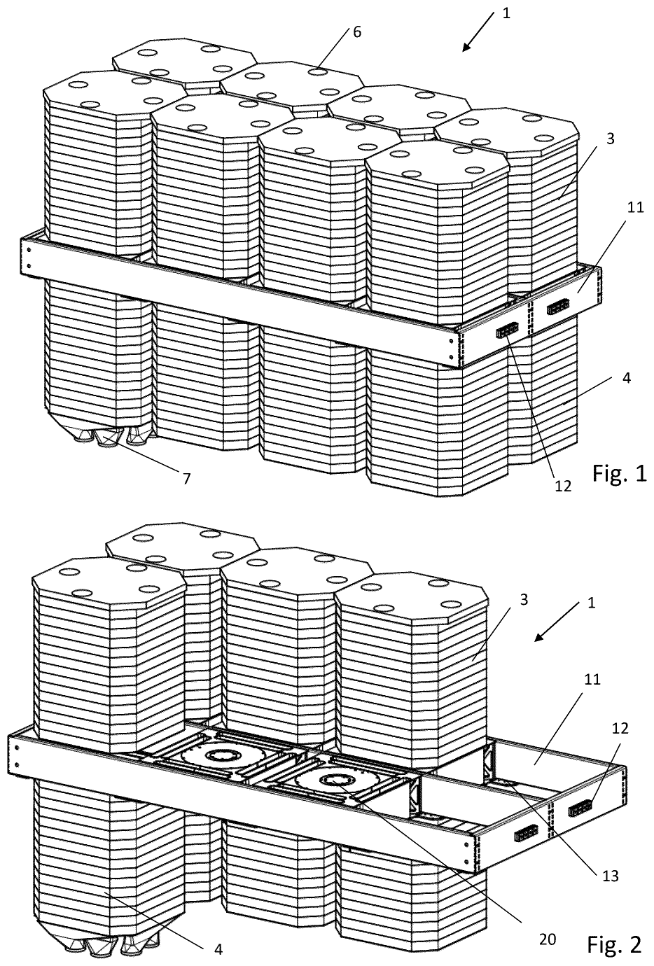

FIG. 1 shows a plansifter 1 as is applied in cereal mills. FIG. 2 shows the plansifter with partially removed sieve stacks and partially removed drive modules. The plansifter includes a plurality of only schematically represented upper sieve stacks 3 and lower sieve stacks 4, the sieve stacks being assembled via a common suspension device such that common horizontally oscillating movements are possible. Furthermore, the plansifter includes flexible feed conduits as a sieve material inlet as well as likewise flexible outlet conduits as a sieve material outlet. In FIG. 1, one sees upper-side inlets 6 onto which the feed conduits are connected, as well as lower-side outlets 7 for the outlet conduits. The sieve stacks 3, 4 can also optionally be present in each sieve box as an alternative to a construction without an additional outer sieve compartment housing.

A mount 11 serves as a mechanical carrier structure. It forms a carrier frame and receives the drive modules which are hereinafter yet described in more detail. The sieve stacks are fastened to the drive modules and herewith indirectly to the mount 11, for example by way of a clamping system of rods and/or belts and/or other means; the clamping system is not represented in FIGS. 1 and 2.

The mount 11 can include fastening structures 12 for the suspension device (which is formed for example in the manner known per se by way of flexible rods). Furthermore, it can form a cable feed for the drive modules 20, i.e. the mount 11 can also receive the electrical leads, for example in a hollowed out part in the inside of the elements which form the carrier frame.

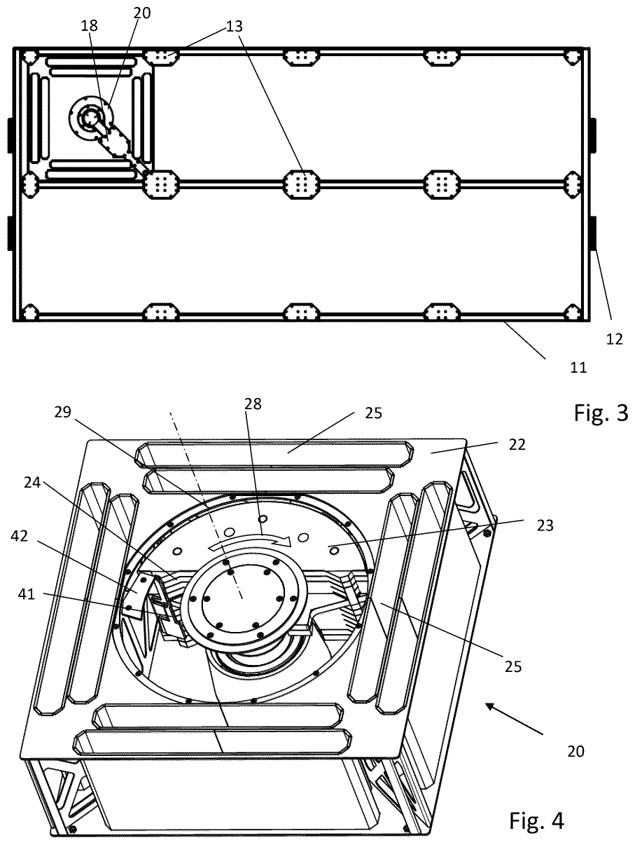

As one can see in particular also in the lower view of the mount 11 according to FIG. 3, the mount is essentially open. It includes rests 13, on which the drive modules 20 can be placed and relative to which they can also be fastened. The rests 13 are arranged such that the drive modules 20 lie on them in the region of their lower corners.

A possibility of an electrical feed 18 which connects the electric motor of the drive module 20 to the feed conduits in the mount 11 and which here is led along the lower side of the drive module can also be seen in FIG. 3.

FIG. 4 shows a drive module 20 in an oblique view from the upper side. The drive module, defined by a housing 22, has a rectangular, in particular essentially square layout. What is of significance for the functioning is the inertial weight 23 which here is constructed of a plurality of plate elements 24 (other embodiments, for example of a monolithic block or other components would also be possible) and which can be brought into a circling movement by way of an electric motor which is described hereinafter in yet more detail. The rotation direction 28 is represented in FIG. 4 by a block arrow and the rotation axis 29 is also indicated in FIG. 4. In this text, the terms such as “radial”, “axial”, etc. relate to this rotation axis 29 inasmuch as a different significance is not expressly referred to. Of course, the manner of functioning of the present invention does not depend on the rotation direction. The rotation direction and everything which this entails can also be the other way round, wherein then the mechanical stop which is described in more detail below would then possibly be installed at the other side. The rotation direction for example can be configurable.

The drive module 20 further includes eight through-channels 25, along each side an outer and an inner through-channel 25. All through-channels 25 thus also the inner through-channels are arranged radially outside the path which is described by the inertial weight 23. The inertial weight is constructed such that it has a large mass and is arranged as far to the outside as possible within the space which is available to it, which is why it roughly has the shape of a ring segment whose axial (vertical) extension corresponds essentially to the complete vertical extension of the drive module.

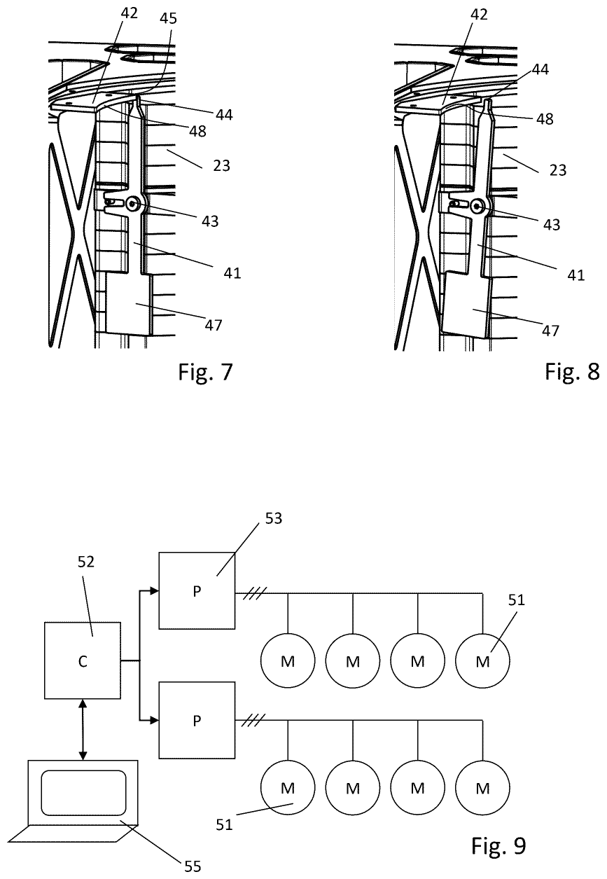

In FIG. 4 one can also see a swing tab 41 and a stop plate 42 which serve for bringing the inertial weight 23 into a defined position before starting operation, which will yet be explained in more detail hereinafter by way of FIG. 7 and FIG. 8.

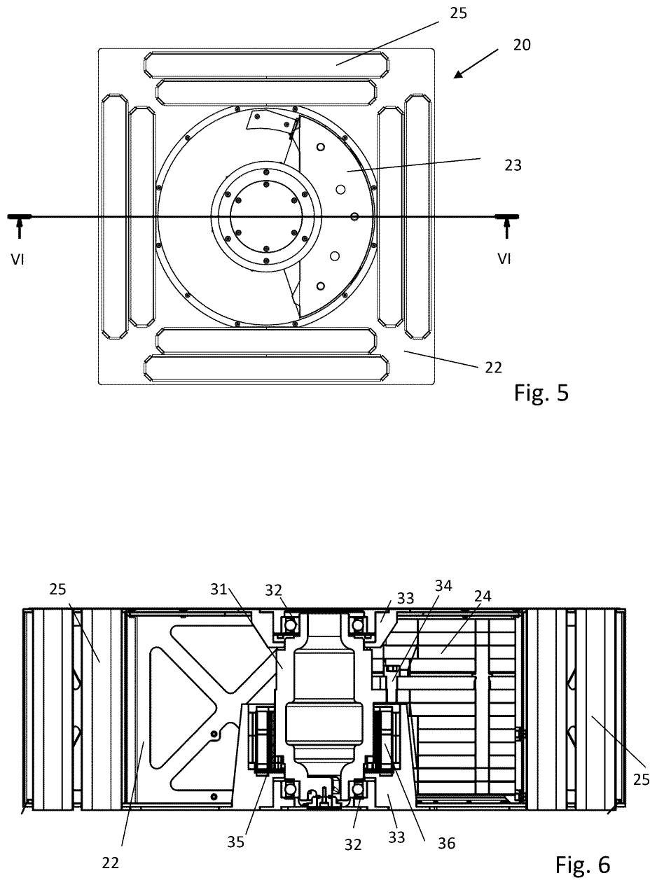

FIG. 5 shows the drive module in a view from above, and FIG. 6 shows a section through the plane VI-VI in FIG. 5. Apart from the through-channels 25, in FIG. 6 in particular one sees the shaft 31 which with a ball bearing 32 each at the upper side and lower side is rotatably mounted relative to the housing 22 by way of a holder 33. The inertial weight 24 is fastened to the shaft 31 (fastening means 34).

The shaft 31 is connected to the rotor of the electric motor in a direct manner, i.e. without gear, belts, gearwheels or other transmission means which possibly convert the rotation speed, or forms this rotor. In the represented embodiment, permanent magnets 35 which are attached to the shaft 31 at the outside form the rotor of the electric motor, whereas the stator 36 with the coils and soft magnets for generating a magnetic rotary field is fastened to the housing.

FIGS. 7 and 8 illustrate a possibility of bringing the inertial weight into a defined position before the starting of the machine. This can be necessary if for example, given an interruption of operation, the inertial weights of the different drive modules run out differential far. If the inertial weights 23 of the drive modules 20 are brought into a defined position in a common procedure before starting, a synchronous operation is possible and specifically even if a plurality of motors are operated with a common power stage (with a common power-electronics converter).

For this purpose, a swing tab 41 is fastened to the inertial weight 23, the swing tab interacting with a stop plate 42 given a slow backwards rotation (corresponding to a movement towards the viewer in FIGS. 7 and 8), in order to form a stop, whereas a rotation in the opposite forwards direction (rotation direction 28 in FIG. 4) is not prevented.

The swing tab is pivotably mounted about an axis 43. FIG. 7 shows the state in which the tip 44 of the swing tab abuts on the stop 45 which is formed by the stop plate 42—this for example can be fastened to a lid which is not visible in FIGS. 7 and 8. A backwards movement beyond the position according to FIG. 7 is not possible.

In contrast, a forwards movement is not prevented by the stop plate 42 since the radially inner narrow side of the stop plate 42 forms a ramp 48 which deflects the swing tab 41 given a movement in the forwards direction.

In order, given a rapid rotation in the forwards direction, for the tip 44 of the swing tab 41 not to be present on the ramp 48 with each revolution and for the swing tab to be deflected, the centre of gravity of the swing tab 41 is arranged below the axis 43. In the drawn example, this is effected by way of a weight portion 47 of the swing tab 41 below the axis 43. If the inertial weight rests or moves only slowly, the swing tab 41 is aligned vertically according to FIG. 7. Given a rapid rotation, the centrifugal force effects a deflection into the position which is drawn in FIG. 8 and in which the tip 44 of the swing tab is radially within the stop plate 42 and does not contact this at any point in time.

The machine can now be programmed such that on starting it can firstly let the motors move slowly by at least approximately a complete revolution in the backwards direction, so that all inertial weights are reliably pressed onto the stop. They are then all in the defined position. The motors are then all brought into a rotation in the forwards direction in a synchronised manner.

FIG. 9 illustrates the principle of feeding several of the motors 51 of the different drive modules by way of a common power stage 53. Eight motors are illustrated in FIG. 9, wherein each motor belongs to one of the drive modules 20 and is a synchronous motor, for example as described by way of FIG. 6 with a rotor with at least one permanent magnet 35. In the embodiment of FIG. 9, four motors are assigned to one of the two power stages 53 and thus form a common motor cluster-with regard to closed-loop control technology they quasi correspond to a single motor. On operation, the motors with a common power stage 53 run synchronously per se by way of the same rotary field being generated in each of the motors and the rotors following the rotary field.

The control for the power switches in the power stages 53 is effected by way of a common control module 52. This includes one position sensor per power stage 53 for the absolute position.

On physically realising the machine and alternatively to the drawn configuration, the control can also be an integral constituent of the power stages 53.

In embodiments, the machine is configured to exactly specify the speed by way of the control module 52 and for this to also be displayed. The sieving efficiency can be optimised by way of the selection of the appropriate speed.

An input and/or output unit 55 via which the speed can be set and from which it can be read off is schematically drawn in FIG. 9. The input and/or output unit 55 is schematically illustrated as a computer in FIG. 9, the computer commutating with the control module via an interface. However, other solutions are also conceivable, for example an operating panel on the control module, an operating element (slide control, rotary knob) with a read-off possibility.

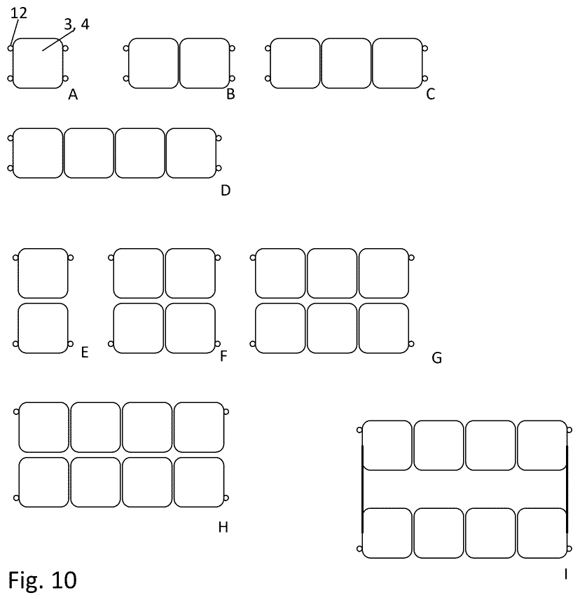

One advantage of the approach according to the invention which has already been mentioned above is the fact that the number and arrangement of the sieve stack pairs is basically freely configurable and an uneven number of sieve stack pairs is also possible. FIG. 10 illustrates a plurality of possibilities. Each of the pictures A-I schematically represents an arrangement of sieve stack pairs 3, 4 and moreover illustrates possible positions of fastening structures 12 for a suspension device.

According to arrangement A, a machine can include only a single sieve stack pair. Arrangements B-D respectively show 2, 3 and 4 sieve stack pairs arranged in a row and longer rows are also conceivable. Arrangements E-H each include two rows of sieve stack pairs. One can also see that in contrast to the state of the art, essentially no distance is necessary between adjacent rows, whereas in the state of the art the drive module is generally present between two rows which is why these need to have a greater distance to one another, as is also the case for example in arrangement I. Arrangements with two (or also more) rows and with greater distances between the rows, as is represented in FIG. 1—also with less or more sieve stack pairs per row than is represented in FIG. 10—however are also an option with machines according to the invention. The space between the rows can then be used in a suitable manner if required, since it requires no larger drive module which is horizontally distanced to the sieve stack pairs, as is the case with sieve stacks in the state of the art.

Many further arrangements are conceivable. For example, given a mount as is represented in FIG. 3, individual positions can also remain vacant. Alternatively, arrangements with three rows of sieve stack pairs or even irregular arrangement are conceivable if the suspension is adapted accordingly.

1. A machine for fractionating ground cereal products, comprising a plurality of sieve stack pairs, the sieve stack pairs being arranged next to one another, each of the sieve stack pairs having an upper sieve stack and a lower sieve stack, further comprising a drive modules, each drive module being between the upper and the lower sieve stack of the plurality of the sieve stack pairs, wherein the drive modules each comprise an electric motor and an inertial weight which can be driven by this into a rotation movement.

2. The machine according to claim 1, which is configured to synchronously drive the inertial weights of the drive modules.

3. The machine according to claim 1, wherein the drive modules each comprise a shaft which is rotatable relative to a base body, wherein the electric motors each comprise a stator and a rotor and wherein the rotor is connected to the shaft in a rotationally fixed manner or is formed by this.

4. The machine according to claim 1, wherein the electric motors are synchronous motors with permanent magnets.

5. The machine according to claim 1, wherein the drive modules each comprise a plurality of through-channels, through which shares of ground cereal product can get from the upper sieve stack to the lower sieve stack.

6. The machine according to claim 1, wherein the drive modules each comprise a housing with a rectangular layout.

7. The machine according to claim 1, comprising a mount, in which the drive modules are received.

8. The machine according to claim 7, wherein the mount comprises fastening structures for a suspension device for suspending the machine, and wherein the upper sieve stacks lie directly or indirectly on the mount and the lower sieve stacks are suspended directly or indirectly on the mount.

9. The machine according to claim 7, wherein the mount receives electric leads for supplying the electric motors of the drive modules.

10. The machine according to claim 1, wherein the electric motors of a plurality of drive modules are fed by a common power stage.

11. The machine according to claim 1, which is configured, on starting, to move the inertial weights in a direction counter to an envisaged rotation direction until they are present on a mechanical stop, and only subsequently to bring them into a rotation movement in the envisaged rotation direction.

12. The machine according to claim 11, wherein the mechanical stop is formed by a swing element which given a rotation movement of the inertial weight in the envisaged rotation direction is deflected from a home position into a deflected position in which deflected position it does not inhibit the rotation movement.

13. The machine according to claim 1, wherein a speed of the inertial weights is selectable and wherein the machine is configured such that the speed can be read off.

14. A method for operating a machine according to claim 1, wherein the inertial weights of the drive modules are brought into a synchronous rotation movement, whilst a unit with the sieve stacks and the drive modules is mounted such that they are capable of circling horizontal oscillations.
